(19) United States
(12) Patent Application Publication
(10) Pub. No.: US 2012/0298537 A1
(43) Pub. Date: Nov. 29, 2012

(54) BASEBALL BUCKET STAND

(76) Inventor: Ed Calderon, Canyon Country, CA (US)

(21) Appl. No.: 13/113,257

(22) Filed: May 23, 2011

(51) Int. Cl. B65D 85/00; F16M 11/22

(52) U.S. Cl. 206/315.9; 248/146

(57) ABSTRACT

A baseball bucket stand. A bottom section has a horizontal bottom plate and a vertical tube connected to the top of the horizontal bottom plate. An upper section for extending the height of the bottom section is positioned above the bottom section. A ball bucket is positioned above the upper section. The upper section extends into the ball bucket balancing the ball bucket and supporting the weight of the ball bucket and its contents. In a preferred embodiment, the upper section and lower section can be placed inside the ball bucket so that the user can carry the ball bucket, the upper section and lower section to a desired location for easy assembly. Preferably baseballs are placed in the ball bucket.

The present invention relates to ball holding devices, and in particular to ball holding devices used for holding balls at an elevated height.

### BACKGROUND OF THE INVENTION

Baseball is probably the most popular sport in the United States and one of the most popular sports in the world. Small kids start to play baseball at 5 or 6 years old and continue to play it throughout their childhood. The best players are able to continue playing through high school and college. The truly elite players hope to play at the professional level as adults.

Players and coaches know that in order to be successful that it is very important to practice. Practice drills that allow the player to repeatedly sharpen his skill are preferred. For example, the 6 year old beginner and the world's most skilled home run king both know that they need to practice hitting throughout the season to stay on top of their hitting and to improve. There are many modern pitching machines that can automatically feed baseballs repeatedly to the batter. However, the best way to practice hitting a baseball is to have a real person actually pitch it to the batter.

Repeated pitches can be difficult for the pitching coach. His pitching arm can tire. Also, it can be damaging and painful to the pitching coach's knees and back to repeatedly lean over and pick up balls that are lying on the ground. In the prior art there are a variety of baseball bucket stands available to the consumer. However, the prior art baseball bucket stands tend to be expensive, cumbersome and awkward to use. During baseball practice it is important that the equipment is easy and convenient for the coach and manager to utilize.

What is needed is a better baseball bucket stand.

### SUMMARY OF THE INVENTION

The present invention provides a baseball bucket stand. A bottom section has a horizontal bottom plate and a vertical tube connected to the top of the horizontal bottom plate. An upper section for extending the height of the bottom section is positioned above the bottom section. A ball bucket is positioned above the upper section. The upper section extends into the ball bucket balancing the ball bucket and supporting the weight of the ball bucket and its contents. In a preferred embodiment, the upper section and lower section can be placed inside the ball bucket so that the user can carry the ball bucket, the upper section and lower section to a desired location for easy assembly. Preferably baseballs are placed in the ball bucket.

### BRIEF DESCRIPTION OF THE DRAWINGS

FIG. 1 shows an exploded view of a preferred embodiment of the present invention.

FIG. 2 shows a side view of a preferred embodiment of the present invention.

FIG. 3 shows a preferred bucket.

FIGS. 4-5 show a preferred bottom section.

FIG. 6 shows a preferred upper section.

FIG. 7 shows a preferred bucket.

FIGS. 8-9 show a preferred cap arrangement.

FIG. 10 shows baseballs placed in a preferred baseball bucket stand.

FIG. 11 shows a preferred embodiment of the present invention.

FIG. 12 shows another preferred embodiment of the present invention.

### DETAILED DESCRIPTION OF THE PREFERRED EMBODIMENTS

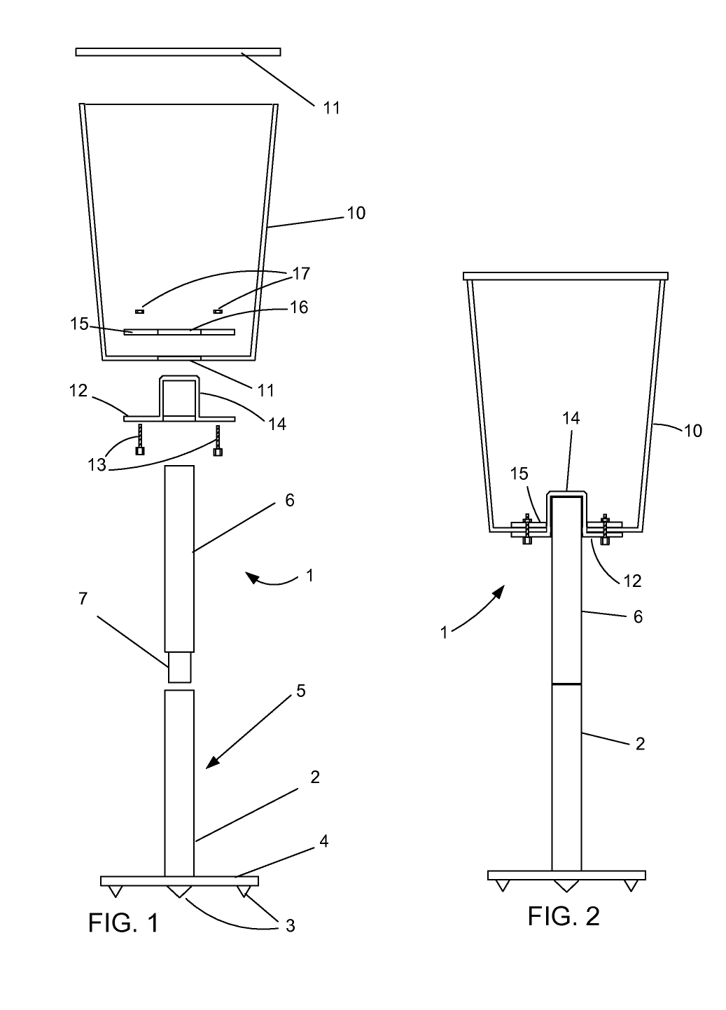

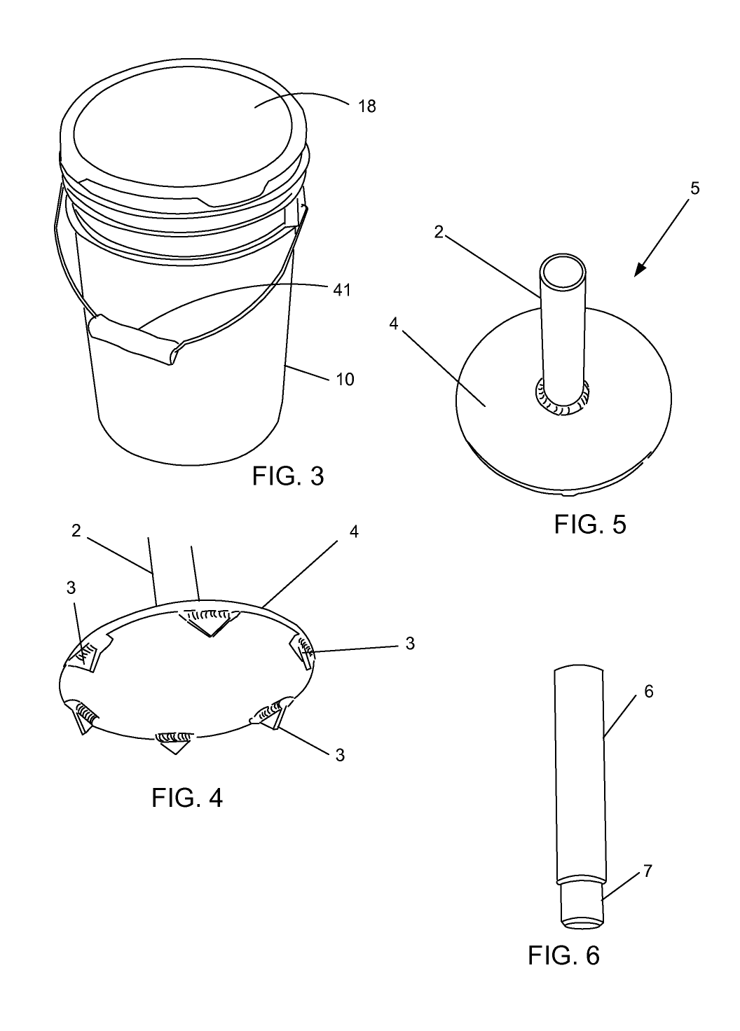

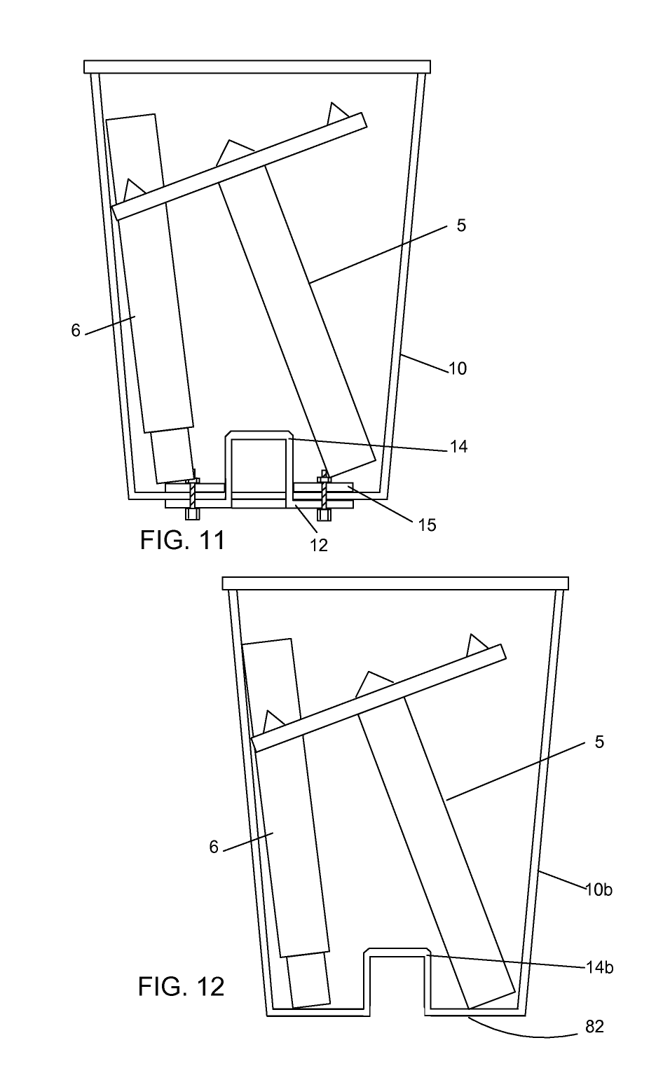

FIG. 1 shows an exploded view of bucket stand 1 and FIG. 2 shows an assembled view of bucket stand 1. Bucket stand 1 allows the user to place all of the components of the stand into bucket 10 and carry it to a desired location at the practice (FIG. 11 and FIG. 3). The user can then easily assemble bucket stand 1, place the balls in bucket 10 and begin practicing.

### Components of a Preferred Bucket Stand

The components of bucket stand 1 include bottom section 5, upper section 6 and bucket 10. Preferably, bottom section 5 and upper section 6 are fabricated from aluminum. Aluminum is strong and lightweight. Bucket 10 is preferably hard plastic.

Bottom section 5 includes vertical bottom tube 2 and horizontal bottom plate 4. Preferably vertical bottom tube 2 and is approximately 11.5 inches long and is welded to horizontal bottom plate 4 as shown in FIG. 5. Preferably horizontal bottom plate 4 has a diameter of 10 ⅜ inches. As shown in FIG. 4, cleats 3 (extending approximately 1.5 inches downward) are preferably welded to plate 4.

As shown in FIG. 1, upper section 6 (preferably approximately 11.5 inches long) is positioned above bottom section 5 and includes small diameter insert section 7. Insert section 7 is slid into vertical bottom tube 2 to extend the height of bottom section 5, as shown in FIG. 2. FIG. 6 shows a perspective view of upper section 6.

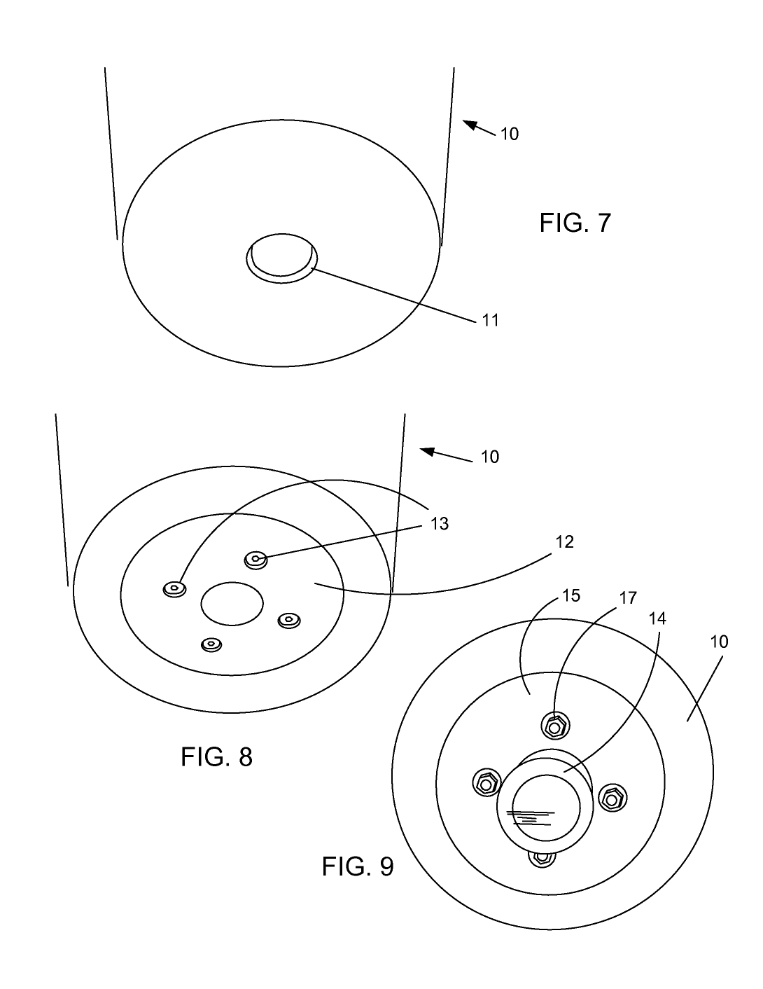

As shown in FIG. 1, bucket 10 includes hole 11 cut into its bottom (see also FIG. 7). Bucket bottom plate 12 has a diameter of preferably 6 inches and is positioned below the bottom of bucket 10. Bottom plate 12 includes cap 14. Cap 14 is inserted into hole 11 as shown (see also FIGS. 8 and 9). FIG. 9 shows a top view of the bottom of bucket 11 with cap 14 inserted as described. Bucket top plate 15 fits over hole 11 and cap 14 is inserted through hole 16 in top plate 15. Top plate 15 (having a diameter of approximately 6 inches) is bolted to bucket 10 utilizing bolts 13 and nuts 17. Cap 14 extends into the interior of bucket 10. The top portion of upper section 6 extends into bucket 10 so that cap 14 rests on the top of upper section 6. Bucket 10 is then balanced and the weight of bucket 10 and the balls held in bucket 10 is properly supported.

Lid 18 may be placed on top of bucket 10 as desired. Bottom plate 12 and top plate 15 are also preferably aluminum.

### Preferred Method of Using the Ball Holder

Preferably bucket 10 includes handle 41 for permitting the user to carry the bucket (FIG. 3). As shown in FIG. 11, bottom plate 12 with cap 14 is kept bolted to bucket 10 by utilization of top plate 15 (see above discussion). Bottom section 5 and upper section 6 are placed in bucket 10. Utilizing handle 41 (FIG. 3), the user can now easily carry bucket 10 to a desired location, such as a baseball field.

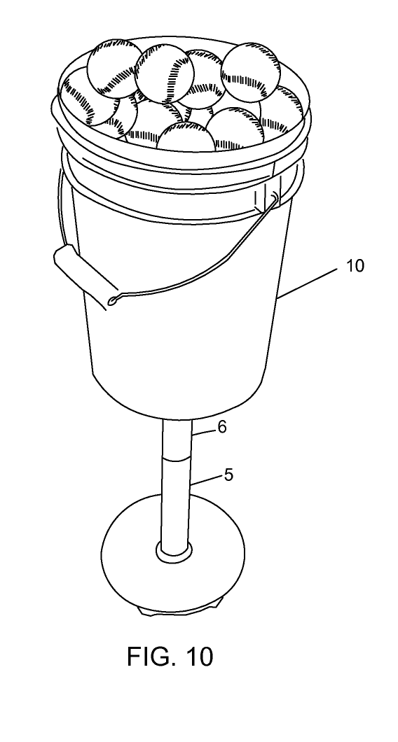

Once at his desired location, the user can remove lid 18 and then remove bottom section 5 and upper section 6. The user can then place bottom section 5 onto the ground (FIGS. 1 and 2). Cleats 3 will dig into the earth and provide support and traction. Upper section 6 is then placed on top of bottom section 5. Bucket 10 is then set on top of upper section 6 so that cap 14 contacts the top of upper section 6. Baseballs can then be placed inside bucket 10 (FIG. 10).

### Bottom of Bucket with Molded Cap

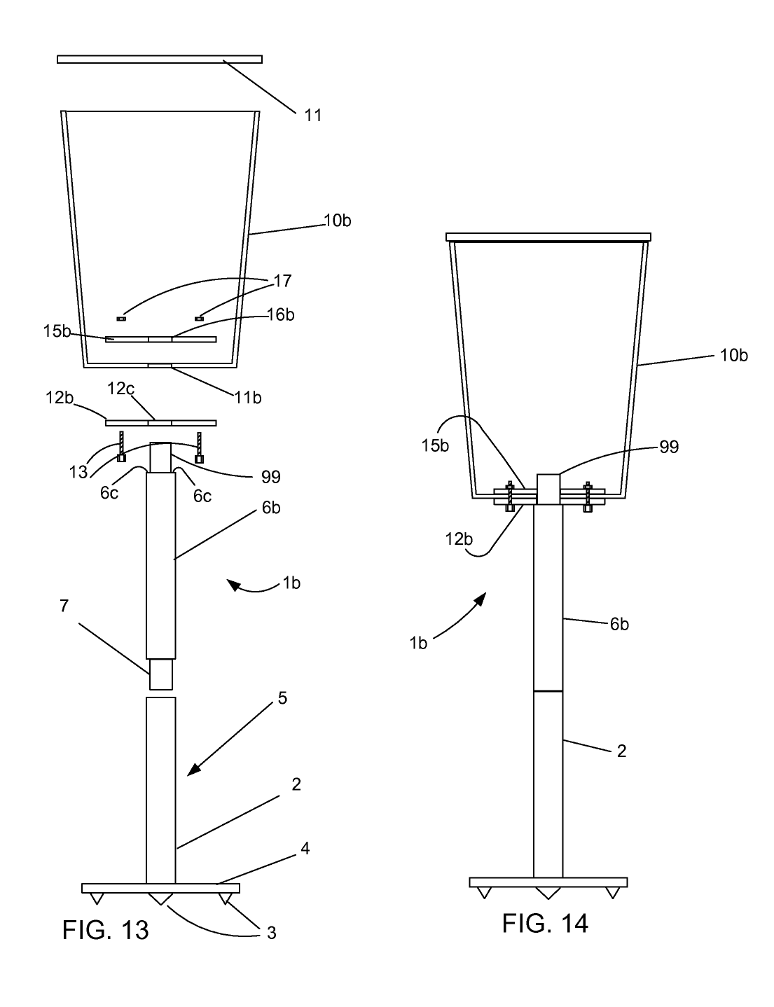

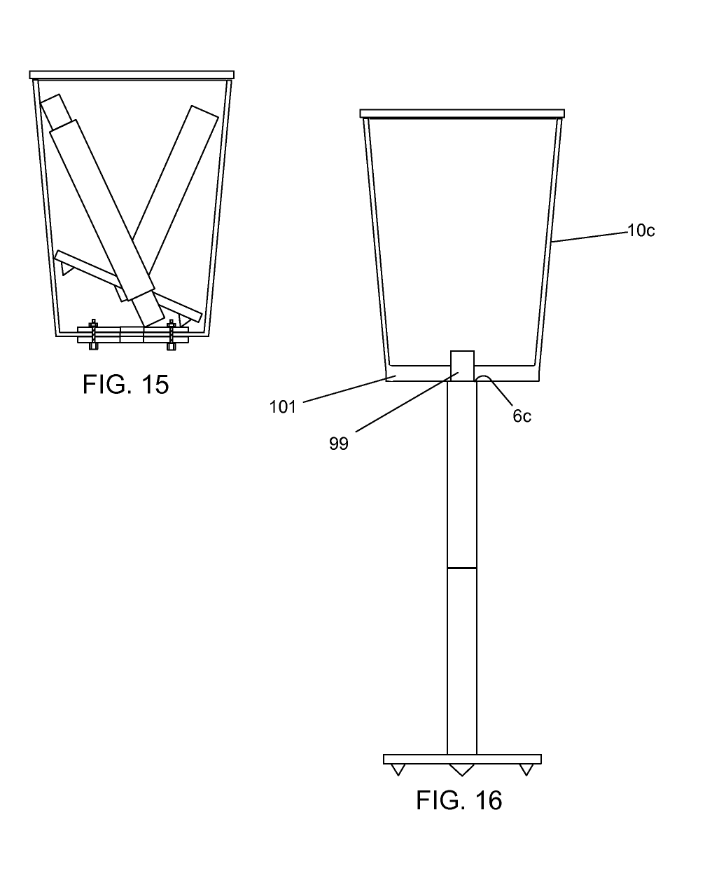

FIG. 12 shows another preferred embodiment of the present invention. In FIG. 12, bucket 10b has been fabricated to include bucket bottom 82. Bucket bottom 82 includes molded cap 14b. Molded cap 14b functions in a fashion similar to cap 14 in that molded cap 14b supports bucket 10b when it is placed over upper section 6.

### Other Preferred Embodiment of the Present Invention

FIGS. 13-15 show another preferred embodiment of the present invention. Bucket stand 1b includes upper section 6b. Bucket insertion piece 99 inserts through hole 12c of bottom bucket plate 12b, through hole 11b and through hole 16b of top bucket plate 15b. In a preferred embodiment holes 12c, 11b and 16b are all approximately 1 ⅝ inches. After insertion piece 99 has been inserted the weight of bucket 10b and its contents is supported by edge 6c of upper section 6b. Bucket 10b is balanced by insertion piece 99 pressed against bottom bucket plate 12b, bucket 10b and top bucket plate 15b. As with the earlier preferred embodiment bottom section 2 and upper section 6b can be placed inside bucket 10 for easy transport to a location desired by the user (FIG. 15).

### Other Preferred Embodiment

FIG. 16 shows another preferred embodiment of the present invention. Bucket 10c has been fabricated with a thick bottom 101. Insertion piece 99 inserts through a 1 ⅝ inch hole in the bottom 101. After insertion piece 99 has been inserted the weight of bucket 10c and its contents is supported by edge 6c of upper section 6b. Bucket 10c is balanced by insertion piece 99 pressed against bottom 101. To properly balance bucket 10c, bottom 101 is preferably at least approximately 1.5 inches thick.

Although the above-preferred embodiments have been described with specificity, persons skilled in this art will recognize that many changes to the specific embodiments disclosed above could be made without departing from the spirit of the invention. For example, although FIG. 4 shows six cleats 3 attached to horizontal bottom plate 4, it would be possible to modify the number of cleats 3. In another preferred embodiment four cleats 3 are attached to the bottom of horizontal plate 4. Therefore, the attached claims and their legal equivalents should determine the scope of the invention.

1-12. (canceled)

13) A bucket stand, comprising:
A) a bottom section for providing stability and support,
B) an upper section removably positioned above said bottom section, said upper section for extending the height of said bottom section, and
C) a ball bucket removably position above said upper section,
wherein said upper section is removable connected to said ball bucket, wherein the weight of said ball bucket is supported by said upper section and wherein said ball bucket is balance by said upper section.

14) The bucket stand as in claim 13, wherein said upper section extends into said ball bucket.

15) The bucket stand as in claim 13, wherein baseballs are stored in said ball bucket.

16) The bucket stand as in claim 13, wherein said bottom section comprises:
A) a horizontal bottom plate, and
B) a vertical bottom tube connected to the top of said horizontal bottom plate.

17) The bucket stand as in claim 13 further comprising a cap attached to the bottom of said ball bucket, wherein said cap extends into the interior of said ball bucket, wherein said upper section extends into said cap and wherein said cap rests on said upper section to balance said ball bucket and to support the weight of said ball bucket and its contents.)

18) The bucket stand as in claim 13, wherein baseballs are placed inside said ball bucket.

19) The bucket stand as in claim 16, wherein said horizontal bottom plate comprises a plurality of cleats attached to the bottom of said horizontal bottom plate.

20) The bucket stand as in claim 13, wherein said upper section comprises a small diameter insert section for inserting into said bottom section so as to connect said upper section to said bottom section.

21) The bucket stand as in claim 13, wherein said ball bucket comprises:
A) a handle for carrying said ball bucket, and
B) a removable lid for covering said ball bucket.

22) The bucket stand as in claim 17, wherein a hole is cut into the bottom of said ball bucket, wherein said cap comprises:
A) a bucket bottom plate, wherein said cap is attached to said bucket bottom plate, wherein said bucket bottom plate is positioned below the hole cut into said ball bucket, and
B) a bucket top plate, positioned over the top of the hole cut into said ball bucket, wherein said bucket bottom plate is rigidly connected to said bucket top plate allowing said cap to extend into the interior of said ball bucket.

23) The bucket stand as in claim 17, wherein said cap is molded into the bottom of said ball bucket.

24) The bucket stand as in claim 13, wherein said ball bucket comprises a handle for carrying said ball bucket, wherein said bottom section and said upper section are storable inside said ball bucket so that a user can grab said handle and carry said ball bucket, said bottom section and said lower section to a desired location.

25) The bucket stand as in claim 13, wherein said bottom section and said upper section are storable inside said ball bucket so that a user can grab said ball bucket and carry said ball bucket, said bottom section and said lower section to a desired location.

26) The bucket stand as in claim 13, wherein a hole is cut into the bottom of said ball bucket, further comprising:
A) an upper section insertion piece connected to said upper section,
B) a bucket bottom plate, positioned below the hole cut into said ball bucket, and
C) a bucket top plate, positioned over the top of the hole cut into said ball bucket, wherein said bucket bottom plate is rigidly connected to said bucket top plate allowing said upper section insertion piece to extend into said ball bucket, wherein the weight of said ball bucket is supported by said upper section and wherein said ball bucket is balance by said insertion piece pressed against said ball bucket, said bucket bottom plate and said bucket top plate.

27) The bucket stand as in claim 13, wherein a hole is cut into the bottom of said ball bucket, further comprising an upper section insertion piece connected to said upper section, wherein the weight of said ball bucket is supported by said upper section and wherein said ball bucket is balance by said insertion piece pressed against the sides of said hole cut into the bottom of said ball bucket.

28) The bucket stand as in claim 27, wherein the bottom of said ball bucket is at least approximately 1.5 inches thick and wherein said upper section insertion piece comprises a circular cross section having a diameter of approximately 1 ⅝ inches.

29) A bucket stand, comprising:
A) a bottom section for providing stability and support,
B) an upper section removably positioned above said bottom section, said upper section for extending the height of said bottom section, and
C) a ball bucket removably position above said upper section,
wherein said upper section is removably connected to said ball bucket, wherein the weight of said ball bucket is supported by said upper section and wherein said ball bucket is balance by said upper section, wherein said bottom section and said upper section are storable inside said ball bucket so that a user can grab said ball bucket and carry said ball bucket, said bottom section and said lower section to a desired location.

30) The bucket stand as in claim 29, wherein said upper section extends into said ball bucket.
